(19) United States
(12) Patent Application Publication
(10) Pub. No.: US 2005/0244015 A1
(43) Pub. Date: Nov. 3, 2005

(54) Method and apparatus to evaluate sound quality according to a measuring mode

(76) Inventor: Ho-young Sung, Suwon-si (KR)

Correspondence Address: STANZIONE & KIM, LLP, 919 18TH STREET, N.W., SUITE 440, WASHINGTON, DC, 20006, US

(21) Appl. No.: 11/063,977

(22) Filed: Feb. 24, 2005

(30) Foreign Application Priority Data
May 3, 2004 (KR) 2004-30932

(51) Int. Cl. H04R 29/00

(52) U.S. Cl. 381/58; 381/56

(57) ABSTRACT

A method and apparatus to evaluate sound quality by measuring physical characteristics of an audio system according to one or more measuring modes. The method includes selecting one of an anechoic mode or a room mode as a measuring mode, measuring physical sound characteristics generated by the audio system according to the selected measuring mode, extracting a plurality of sound quality factors including one or more corresponding evaluation items according to the measured physical sound characteristics, mapping the plurality of extracted sound quality factors using scores set according to predetermined values for the evaluation items obtained from a group of sound quality evaluators, and scoring the corresponding evaluation items of the mapped plurality of sound quality factors by adding predetermined weighting factors to the corresponding evaluation items of the mapped sound quality factors, and displaying the scored corresponding evaluation items on a screen with the measuring mode.

### CROSS-REFERENCE TO RELATED APPLICATIONS

This application claims the priority of Korean Patent Application No. 2004-30932, filed on May 3, 2004 in the Korean Intellectual Property Office, the disclosure of which is incorporated herein in its entirety by reference.

### BACKGROUND OF THE INVENTION

1. Field of the Invention

The present general inventive concept relates to evaluation of sound quality, and more particularly, to a method and an apparatus to evaluate sound quality by measuring physical characteristics of an audio system according to measuring modes.

2. Description of the Related Art

General sound quality evaluation of an audio or audio-visual system is typically performed by a skillful sound quality evaluator, i.e., a person who subjectively evaluates the quality of the sound. However, results of this subjective sound quality evaluation may not be accurate and may be inconsistent due to different evaluations performed by different evaluators, evaluator uncertainty, and differences in listening environments in which the evaluations are performed. Furthermore, the subjective sound quality evaluation is expensive and time consuming. Accordingly, the subjective sound quality evaluation is inefficient.

### SUMMARY OF THE INVENTION

The present general inventive concept provides a method of evaluating a sound quality by which evaluation scores based on objective data can be derived by measuring physical characteristics of an audio system, and by which the sound quality in a room mode can be compared by selectively using an anechoic mode and the room mode.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of evaluating a sound quality, the method comprising selecting one of an anechoic mode and a room mode as a measuring mode, measuring physical sound quality and sound characteristics generated from an audio system according to the selected measuring mode, extracting a plurality of sound quality factors including one or more corresponding evaluation items according to the measured physical sound quality and sound characteristics, mapping the plurality of extracted sound quality factors using scores set according to predetermined values for the evaluation items obtained from a group of sound quality evaluators, and scoring the corresponding evaluation items of the mapped plurality of sound quality factors by adding predetermined weighting factors to scores of the corresponding evaluation items of the mapped sound quality factors, and displaying the scored corresponding evaluation items on a screen along with the selected measuring mode.

The foregoing and/or other aspects and advantages of the present general inventive concept may also be achieved by providing a sound quality evaluating apparatus comprising a keypad to select one of an anechoic mode and a room mode as a measuring mode, a digital signal processor to calculate a plurality of sound quality factors including one or more corresponding evaluation items according to measured physical sound quality and sound characteristics of a test signal and the measuring mode selected by the keypad, to map the calculated sound quality factors for each of the corresponding evaluation items using scores set according to predetermined values for the evaluation items obtained from a group of sound quality evaluators, and to score the corresponding evaluation items of the measured sound characteristics by adding predetermined weighting factors to scores of the corresponding evaluation items of the mapped plurality of sound quality factors, and a micro-controller to display sound quality evaluation scores processed by the digital signal processor on a screen along with the selected measuring mode.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating a system and apparatus to automatically evaluate sound quality according to an embodiment of the present general inventive concept;

FIG. 2 is a block diagram illustrating the sound quality evaluating apparatus of FIG. 1;

FIG. 3 is a flowchart illustrating a method of the sound quality evaluating apparatus of FIGS. 1 and 2;

FIG. 4 is a flowchart illustrating a method of evaluating sound quality performed by the sound quality evaluating apparatus of FIGS. 1 and 2; and

FIG. 5A through 5D are flowcharts illustrating a process of calculating sound quality evaluation factors (x) of a sound quality evaluating apparatus.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

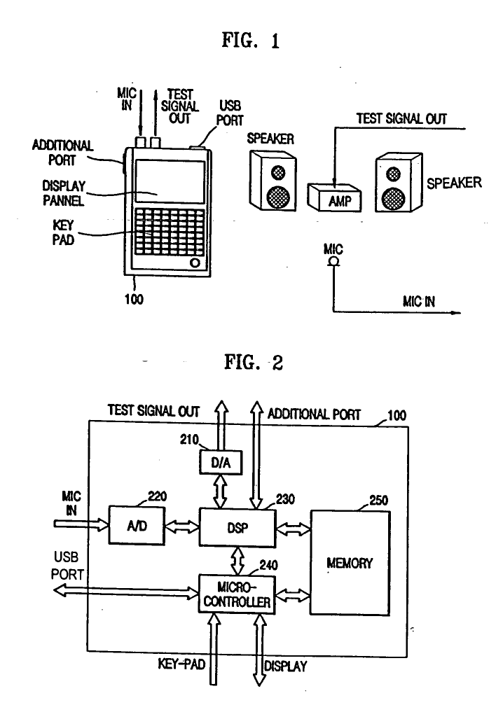

FIG. 1 is a diagram illustrating a system and apparatus to automatically evaluate sound quality according to an embodiment of the present general inventive concept.

Referring to FIG. 1, a microphone (MIC) converts a pressure of a sound to be reproduced by speakers into an electrical signal. An amplifier (AMP) amplifies the electrical signal converted by the MIC to a predetermined level. An audio input/output peripheral unit (not shown) that is installed on a personal computer (PC) (not shown), receives an audio signal amplified by the AMP and outputs a sound. A sound quality evaluating apparatus 100 outputs a test signal through a TEST SIGNAL OUT port and receives a measured impulse response through a MIC IN port. A universal serial bus port (i.e., USB PORT) is used to receive data to upgrade software from an external device or to transmit stored data to the external device. An ADDITIONAL PORT is used to control a turntable (not shown) when the sound quality of an audio system is measured in an anechoic room. A display panel is used to display scores of a sound quality evaluation. A keypad includes a plurality of input keys including a mode key to select one of an anechoic measuring mode or a room measuring mode.

FIG. 2 is a block diagram illustrating the sound quality evaluating apparatus 100 of FIG. 1.

Referring to FIGS. 1 and 2, a digital-to-analog (D/A) converter 210 converts a digital test signal into an analog signal. An analog-to-digital (A/D) converter 220 converts an analog signal input from the MIC into a digital signal. A digital signal processor (DSP) 230 measures physical sound characteristics of an audio signal input to the MIC IN port according to a measuring mode selected by the keypad and determines a plurality of sound quality factors according to the measured physical sound characteristics. The plurality of sound quality factors may include one or more corresponding evaluation items. The DSP 230 then maps the determined plurality of sound quality factors using a scoring system set according to a plurality of predetermined values for the evaluation items of the sound quality evaluation factors obtained from a group of sound quality evaluators. The DSP 230 scores the corresponding evaluation items by adding predetermined weighting factors associated with each of the corresponding evaluation items to the scores of the plurality of the sound quality factors determined according to the scoring system. A micro-controller 240 processes interrupts, displays, communicates with the USB PORT, and performs a sound quality evaluation method in real-time. In particular, the micro-controller 240 displays sound quality evaluation scores processed by the DSP 230 on a screen of the display panel along with the selected measuring mode. A memory 250 stores programs and data for the DSP 230 and the micro-controller 240. A PC program (not shown) is installed on the PC and controls the audio input/output and the turntable that includes the speakers.

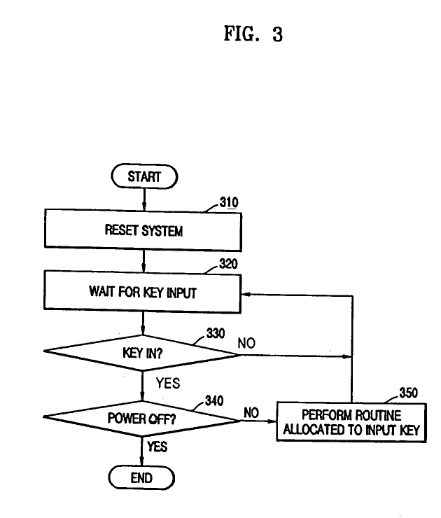

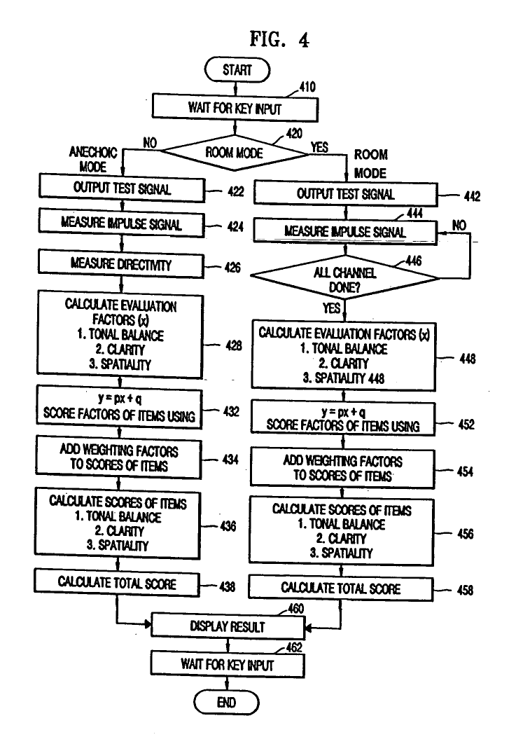

FIG. 3 is a flowchart illustrating a program of the sound quality evaluating apparatus 100 of FIGS. 1 and 2.

At operation 310, the sound quality evaluating apparatus 100 (see FIG. 1) is reset.

At operation 320, the sound quality evaluating apparatus 100 (see FIG. 1) waits for a key input.

At operation 330, the sound quality evaluating apparatus 100 (see FIG. 1) confirms a key input. At operation 340, a process of confirming a power off status is performed. At operation 350, once it is determined that the power is on and the key input is received, a routine allocated to a selected input key is performed.

FIG. 4 is a flowchart illustrating a method of evaluating sound quality using the sound quality evaluating apparatus 100 of FIGS. 1 and 2.

Before the method of evaluating sound quality is performed, a subjective sound quality evaluation model is built. That is, subjective sound quality evaluation values are determined by having a group of sound quality evaluators evaluate a plurality of audio and audio/video systems. Physical sound data is measured from an audio or audio/video system to be evaluated and converted into various sound quality factors. Additionally, values for the corresponding evaluation items of the plurality of sound quality factors are measured for sound data of the plurality of audio or audio/video system. The measured sound quality evaluation factors are mapped to the determined subjective sound quality evaluation values. Here, a method of modeling sound quality evaluation approximates objective sound quality evaluation factors so that the objective sound quality evaluation factors have the same score range as a subjective score range of sound quality evaluation data determined by the group of sound quality evaluators.

In other words, the method of evaluating the sound quality according to the present general inventive concept is able to use the subjective sound quality factors obtained from each and/or all of the sound quality evaluators in the group to create the objective sound quality factors by mapping the subjective sound quality factors to a look-up table or other memory device. Thus, the method of evaluating the sound quality automatically and objectively determines the sound quality according to sound quality input from the group of sound quality evaluators.

After the subjective sound quality evaluation model is built, operation 410 determines whether a “measure” key is input for the method of evaluating sound quality to begin.

If the “measure” key is input, operation 420 determines whether the “measure” key refers to an anechoic measuring mode or a room measuring mode. If the anechoic measuring mode is selected, sound quality evaluation scores are calculated as follows.

At operation 422, a predetermined test signal is output from the sound quality evaluating apparatus 100 (see FIG. 1). At operation 424, an impulse response of the predetermined test signal is measured. At operation 426, directivity data is measured when rotating the turntable including the speakers by a predetermined angle. At operation 428, the measured impulse response and the directivity data are used to calculate a plurality of sound quality factors (x) including values for corresponding evaluation items according to a signal processing theory. For example, the plurality of sound quality factors may include 1. Tonal balance, 2. Clarity, 3. Spatiality, and 4. Ambience. Other sound quality factors may also be determined. An exemplary set of sound factors including corresponding evaluation items is as follows:

1. Tonal balance
1) Spectral deviation
2) Normalized area of peak/dip
3) Bass level, mid level, and treble level
4) Difference between a crossover frequency level and a mean level
5) Midrange spectral deviation
6) Difference between a high treble level and a treble level
7) The amount of level change per frequency band according to volume

2. Clarity
1) The amount of time decay of each of bass, mid, and treble ranges
2) Fluctuating level of a frequency response function of each of bass, mid, and treble ranges

3. Spatiality
1) The number of dips, which are lower than −3 dB comparing to 0° based on a frequency characteristic in a 30° off-axis
2) Fluctuating level as compared with a frequency response function in a 30° angle

4. Ambience
1) Bass level as compared with other bands
2) Fluctuating level as compared with a response function of bass and mid ranges
3) Fluctuating level as compared with a frequency response function in a 30° angle

At operation 432, the sound quality factors (x) including the values for the corresponding evaluation items are mapped to scores (y) using the look-up table set according to predetermined values for each of the corresponding evaluation items obtained from the group of sound quality evaluators. The look-up table may be used to map scores of the sound quality factors. A polynomial function, an exponential function, or a logarithm function may also be used to map the scores of the sound quality factors. Objective sound quality evaluation scores of the sound quality are approximated to have the same scale as the sound quality evaluation scores of evaluation items obtained from the group of sound quality evaluators with respect to the sound quality factors including the corresponding evaluation items that are mapped in the look-up table. The objective sound quality evaluation scores may be expressed with the same score format as the subjective sound quality evaluation scores determined by the group of sound quality evaluators. At operation 434, predetermined weighting factors are set for the scores of the sound quality factors. Here, the weighting factors may subjectively affect scoring of the sound quality and may be adjusted according to a sound quality standard or style that a user prefers. At operation 436, the corresponding evaluation items are scored by adding the predetermined weighting factors to the scores of the sound quality factors. For example, scores of the tonal balance, the clarity, and the spatiality can be evaluated as follows:
Tonal balance score={T₁σ_{Full}+T₂A_{Full-pd}+T₃d_{LowFreq.}+T₄L_{Bass}+T₅L_{Mid}+T₆L_{Treble}+T₇σ_{Mid}+T₈d_{HighTreble}+T₉d_{SatSubCrossover}} 1.
where T₁ to T₉=Tonal balance weighting factor, σ_{Full}=Spectral deviation in a full range, A_{Full-pd}=Normalized area of peaks/dips, L_{Bass}=Bass level, L_{Mid}=Midrange level, L_{Treble}=Treble level, σ_{Mid}=Midrange deviation, d_{HighTreble}=High treble, and d_{SatSubCrossover}=Satellite and subwoofer crossover difference.
Clarity score={C₁A_{Bass}+C₂τ_{Bass}+C₃A_{Mid}+C₄τ_{Mid}+C₅A_{Treble}+C₆τ_{Treble}τ_{Mid}} 2.
where C₁ to C₆=Clarity weighting factor, τ_{Bass}=Bass decay time, τ_{Mid}=Midrange decay time, τ_{Treble}=Treble decay time, A_{Bass}=Fluctuation area-bass, A_{Mid}=Fluctuation area-mid, and A_{Treble}=Fluctuation area-treble.
Spatial score (anechoic measuring mode)={S_{A1}A_{off-axis}+S_{A2}N_{Dip30}} 3.
where S_{A1}, S_{A2}=anechoic mode spatial weighting factors, A_{off-axis}=Off-axis fluctuation area, and N_{Dip30}=number of dips at 30°.
Spatial score (room measuring mode)={Sᵣ₁L_{FF}+Sᵣ₂σ_{R}+Sᵣ₃L_{RR}} 4.
where Sᵣ₁, Sᵣ₂, Sᵣ₃=room mode spatial weighting factors, L_{FF}=Front channel stereo matching, σ_{R}=Rear speaker spectral deviation, and L_{RR}=Rear channel level matching.

At operation 438, a total score is calculated by adding the scores of all the sound quality factors.

At operation 420, if the room measuring mode is selected, the directivity data is not measured, data of all channels according to a specification of a measured system is measured at operation 446. Therefore, in the room measuring mode, at operations 442, 444, 448, 452, 454, 456, and 458, the sound quality factors and scores of the corresponding evaluation items are calculated in the same manner as in the anechoic measuring mode except that the directivity data is not measured, and the data of all the channels is measured instead.

Additionally, since the directivity data is not measured when the sound quality factors are calculated in the room measuring mode, the spatial score may be calculated using the following corresponding evaluation items: 1) front channel stereo matching, that is, a difference of average levels of response characteristics of front L and R channels in a frequency domain, 2) rear channel spectral deviation, that is, a spectral deviation of rear channel response characteristics, and 3) rear channel level matching, that is, a difference of average levels of response characteristics of rear L and R channels in a frequency domain.

At operation 460, the total scores that are calculated according to the room measuring mode and the anechoic measuring mode are displayed on a screen. The total scores for both the anechoic measuring mode and the room measuring mode may be displayed together on the screen.

At operation 462, the sound quality evaluating apparatus 100 (see FIG. 1) waits for another key input.

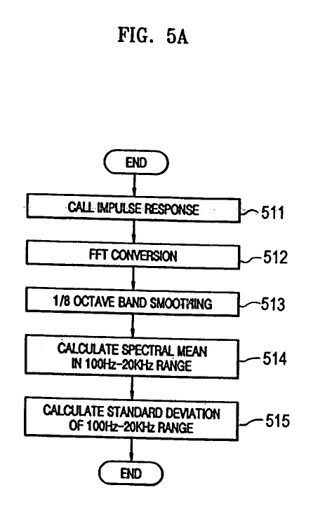

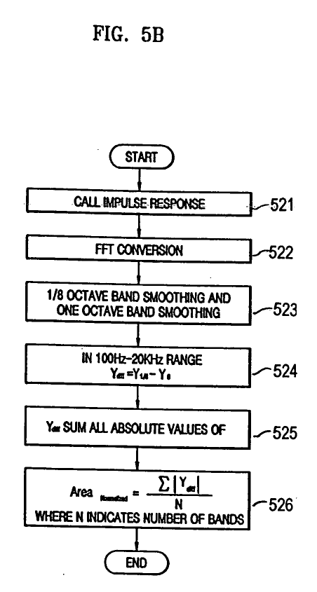

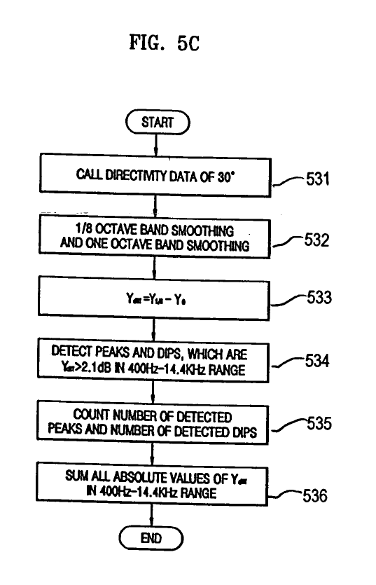

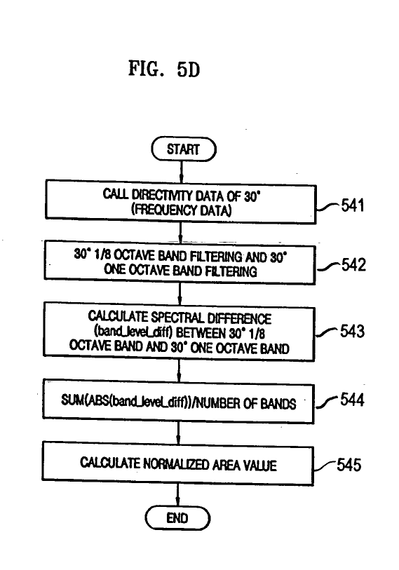

FIG. 5A through 5D are flowcharts illustrating a method of calculating values of the corresponding evaluation values of the sound quality factors (x).

FIG. 5A is a flowchart illustrating a method of calculating a spectral deviation. An impulse response is obtained and converted by performing a Fast Fourier Transform (FFT) thereon at operations 511 and 512, respectively. The FFT converted impulse response is smoothed using a ⅛-octave band at operation 513. A spectral mean is calculated from the impulse response in a 100 Hz-20 KHz range at operation 514. A standard deviation is then calculated from the impulse response in the 100 Hz-20 KHz range at operation 515.

FIG. 5B is a flowchart illustrating a method of calculating a normalized area of a peak/dip. An impulse response is obtained and converted by performing an FFT at operations 521 and 522, respectively. The FFT converted impulse response is smoothed using a ⅛-octave band and a 1-octave band at operation 523. Differences Y_{diff}=Y_{1/8}−Y₁ are then calculated from the impulse response in a 100 Hz-20 KHz range at operation 524. All absolute values of Y_{diff} are added at operation 525. The area of the peak/dip can be represented as {SUM vert Y_diff vert} over a number of bands at operation 526.

FIG. 5C is a flowchart illustrating a method of calculating a number of peaks and dips, which are more than −3 dB as compared with 0° on a frequency characteristic in a 30° off-axis. Thirty degrees of directivity data is obtained at operation 531. The directivity data is smoothed using a ⅛-octave band and a 1-octave band at operation 532. Differences Y_{diff}=Y_{1/8}−Y₁ are then calculated at operation 533. Peaks and dips where Y_{diff} is larger than 2.1 dB in a 400 Hz-14.4 KHz range are detected at operation 534. The number of detected peaks and the number of detected dips are counted at operation 535. All absolute values of Y_{diff} in the 400 Hz-14.4 KHz range are added at operation 536.

FIG. 5D is a flowchart illustrating a method of calculating a fluctuating level as compared with a frequency response function in a 30° angle. Thirty degrees of directivity data is obtained at operation 541. The directivity data is then filtered into a 30° ⅛-octave band and a 30° 1-octave band at operation 542. Spectral differences (band_level_diff) between the 30° ⅛-octave band and the 30° 1-octave band are obtained at operation 543. SUM(ABS(band_level_diff))/the number of bands is calculated at operation 544. A normalized area value is then obtained at operation 545.

The general inventive concept can be implemented in hardware, software, or a combination thereof. Additionally, the general inventive concept may also be embodied as computer-readable codes on a computer-readable recording medium. The computer-readable recording medium may include any data storage device that can store data which can be thereafter be read by a computer system. Examples of the computer-readable recording medium include read-only memory (ROM), random-access memory (RAM), CD-ROMs, magnetic tapes, floppy disks, flash memory, optical data storage devices, and carrier waves (such as data transmission through the Internet). The computer-readable recording medium can also be distributed over network coupled computer systems so that the computer-readable code is stored and executed in a distributed fashion.

As described above, according to the embodiments of the present general inventive concept, a sound quality evaluation standard of objective data is prepared by scoring sound quality subjectively evaluated by a listener according to the objective data, and the sound quality evaluation is simplified by software that uses a DSP and a micro chip. Also, since an anechoic measuring mode and a room measuring mode can be selectively used, a sound quality performance in the room measuring mode can be compared with that in the anechoic measuring mode. The present general inventive concept can be effectively used to perform a development test when arrangement and a room sound field are fixed, such as in a car audio system.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of evaluating sound quality of an audio system, the method comprising:
measuring physical sound characteristics generated from the audio system according to a selected measuring mode, extracting a plurality of sound quality factors including one or more corresponding evaluation items according to the measured physical sound characteristics, mapping the plurality of extracted sound quality factors using scores set according to predetermined values for the evaluation items obtained from a group of sound quality evaluators, and scoring the corresponding evaluation items of the mapped plurality of sound quality factors by adding predetermined weighting factors to the scores of corresponding evaluation items of the mapped sound quality factors; and
controlling the scored corresponding evaluation items to be displayed on a screen with the selected measuring mode.

2. The method of claim 1, wherein the selected measuring mode is an anechoic mode, and the measuring operation comprises:
measuring an impulse response from an audio signal generated by the audio system and measuring directivity data after rotating the audio system by a predetermined angle;
determining values of the corresponding evaluation items of the extracted sound quality factors by signal processing the measured impulse response and the measured directivity data;
mapping the values of the corresponding evaluation items of the extracted sound quality factors to scores with reference to values set according to the predetermined values for the evaluation items obtained from the group of sound quality evaluators; and
calculating scores of the corresponding evaluation items by adding the predetermined weighting factors to the mapped values of the corresponding evaluation items of the extracted sound quality factors.

3. The method of claim 1, wherein the selected measuring mode is a room mode, and the measuring operation comprises:
measuring signal impulse responses of channels of an audio signal generated by the audio system according to a specification thereof;
determining values of the corresponding evaluation items of the extracted sound quality factors by signal processing the measured signal impulse responses;
mapping the values of the corresponding evaluation items of the extracted sound quality factors to scores with reference to values set according to the predetermined values for the evaluation items obtained from the group of sound quality evaluators; and
calculating scores of the corresponding evaluation items by adding the predetermined weighting factors to the mapped values of the corresponding evaluation items of the extracted sound quality factors.

4. The method of claim 1, wherein the mapping of the plurality of extracted sound quality factors, scores the sound quality on a same scale as sound quality evaluation scores obtained from the group of sound quality evaluators with respect to the plurality of sound quality factors that are mapped.

5. The method of claim 1, wherein the predetermined weighting factors are adjusted according to the measuring mode and a sound quality standard.

6. The method of claim 5, wherein the sound quality standard is determined according to one or more user preferences.

7. The method of claim 1, further comprising:
selecting one of an anechoic mode and a room mode as the selected measuring mode.

8. The method of claim 1, further comprising:
receiving a sound signal from the audio system;
evaluating a plurality of evaluation items of the sound signal to obtain a plurality of corresponding values;
mapping the plurality of corresponding values to a plurality of predetermined values to determine a plurality of scores for each of the plurality of evaluation items of the received sound signal; and
adding the plurality of scores of the plurality of evaluation items to calculate at least one sound quality factor score.

9. A method of automatically evaluating sound quality in an audio system, the method comprising:
receiving a sound signal from the audio system;
evaluating a plurality of evaluation items of the sound signal to obtain a plurality of corresponding values;
mapping the plurality of corresponding values to a plurality of predetermined values to determine a plurality of scores for each of the plurality of evaluation items of the received sound signal; and
adding the plurality of scores of the plurality of evaluation items to calculate at least one sound quality factor score.

10. The method of claim 9, further comprising:
multiplying each of the plurality of scores for the plurality of evaluation items by corresponding weights to affect the at least one sound quality factor score.

11. The method of claim 10, wherein the corresponding weights are determined according to at least one of a predetermined sound quality standard and a user preference.

12. The method of claim 9, wherein the plurality of evaluation items define a plurality of sound quality factors on which the sound quality is evaluated, and the plurality of sound quality factors include one or more of a tonal balance, a clarity, a spatiality, and an ambience.

13. The method of claim 9, wherein the plurality of evaluation items include one or more of:
a spectral deviation;
a normalized area of peaks and dips;
a bass level, a mid level, and a treble level;
a difference between a crossover frequency level and a mean level;
a midrange spectral deviation;
a difference between a high treble level and a treble level;
an amount of level change per frequency band according to volume;
an amount of time decay of each of the bass level, the mid level, and the treble level;
a fluctuating level of a frequency response function of a bass, a mid, and a treble range;
a number of dips that are lower than −3 dB compared to 0° based on a frequency characteristic in a 30° angle;
a bass level compared to other bands;
a fluctuating level as compared with response function of bass and mid ranges; and
a fluctuating level as compared with a frequency response function in a 300 angle.

14. The method of claim 9, wherein the plurality of predetermined values are obtained according to subjective sound preferences of a group of sound quality evaluators to correspond to the evaluation items.

15. The method of claim 14, wherein the plurality of predetermined values are organized into a look-up table.

16. The method of claim 9, further comprising:
adding each of the at least one calculated sound quality factor score to obtain a total sound quality score.

17. The method of claim 9, further comprising:
receiving a selection of a measuring mode,
wherein the selected measuring mode determines the plurality of evaluation items to be evaluated.

18. The method of claim 9, further comprising:
displaying the at least one sound quality factor score and a corresponding measuring mode.

19. The method of claim 9, further comprising:
receiving a measuring mode selection as one of an anechoic mode and a room mode.

20. The method of claim 19, wherein if the selected measuring mode is determined as the anechoic mode, the method further comprises:
measuring an impulse response of the sound signal; and
measuring directivity data of the sound signal from the audio system.

21. The method of claim 19, wherein if the selected measuring mode is determined as the room mode, the method further comprises:
measuring an impulse response of the sound signal; and
measuring data for all channels in the sound signal according to a specification of the audio system.

22. The method of claim 21, wherein if the selected measuring mode is determined to be the room mode,
the evaluation items include one or more of a front channel stereo matching, a rear channel spectral deviation, and a rear channel level matching.

23. The method of claim 9, further comprising:
obtaining subjective sound quality criteria from a group of sound quality evaluators; and
creating objective sound quality criteria according to the subjective sound quality criteria of all the sound quality evaluators in the group to obtain the predetermined values.

24. A method of evaluating sound quality of an audio system, the method comprising:
calculating values of one or more evaluation items of an audio signal;
accessing a score map to map the calculated values of the one or more evaluation items to one or more corresponding scores stored in a memory; and
adding the one or more corresponding scores of the one or more evaluation items to calculated a total sound quality score.

25. The method according to claim 24, further comprising:
receiving one or more subjective scores for one or more predetermined values for the one or more evaluation items;
correlating the one or more subjective scores with the one or more predetermined values for the one or more evaluation items; and
storing the correlations in memory as the score map.

26. A sound quality evaluating apparatus, comprising:
a keypad to select one of an anechoic mode and a room mode as a measuring mode;
a digital signal processor to calculate a plurality of sound quality factors including one or more corresponding evaluation items according to measured sound characteristics of a test signal and the measuring mode selected by the keypad, to map the calculated sound quality factors for each of the corresponding evaluation items using scores set according to predetermined values for the evaluation items obtained from a group of sound quality evaluators, and to score the corresponding evaluation items of the measured sound characteristics by adding predetermined weighting factors to the mapped plurality of sound quality factors; and
a micro-controller to control sound quality evaluation scores processed by the digital signal processor to be displayed on a screen with the selected measuring mode.

27. The apparatus of claim 26, further comprising
a display unit to separately display the sound quality evaluation scores controlled by the micro-controller along with the selected measuring mode.

28. An apparatus to measure sound quality of an audio system, comprising:
an input port to receive an audio signal from the audio system; and
a processor to evaluate a plurality of evaluation items of the sound signal to obtain a plurality of corresponding values, to map the plurality of corresponding values to a plurality of predetermined values to determine a plurality of scores for each of the plurality of evaluation items of the received sound signal, and to add the plurality of scores of the plurality of evaluation items to calculate at least one sound quality factor score.

29. The apparatus of claim 28, further comprising:
a keypad to receive a selection of a measuring mode; and
a display to display the at least one sound quality factor score,
wherein the selected measuring mode determines the plurality of evaluation items to be evaluated.

30. The apparatus of claim 28, wherein the processor further multiplies each of the plurality of scores for the plurality of evaluation items by corresponding weights to affect the at least one sound quality factor score.

31. The apparatus of claim 30, wherein the corresponding weights are determined according to at least one of a predetermined sound quality standard and a user preference.

32. The apparatus of claim 28, wherein the plurality of evaluation items define a plurality of sound quality factors on which the sound quality is evaluated.

33. The apparatus of claim 32, wherein the plurality of sound quality factors include one or more of a tonal balance, a clarity, a spatiality, and an ambience.

34. The apparatus of claim 32, wherein the plurality of evaluation items include one or more of:
a spectral deviation;
a normalized area of peaks and dips;
a bass level, a mid level, and a treble level;
a difference between a crossover frequency level and a mean level;
a midrange spectral deviation;
a difference between a high treble level and a treble level;
an amount of level change per frequency band according to volume;
an amount of time decay of each of the bass level, the mid level, and the treble level;
a fluctuating level of a frequency response function of a bass, a mid, and a treble range;
a number of dips that are lower than −3 dB compared to 0° based on a frequency characteristic in a 30° angle;
a bass level compared to other bands;
a fluctuating level as compared with response function of bass and mid ranges; and
a fluctuating level as compared with a frequency response function in a 30° angle.

35. The apparatus of claim 28, wherein the plurality of predetermined values are obtained according to subjective sound preferences of a group of sound quality evaluators and are aggregated to create an objective scoring system.

36. The apparatus of claim 35, wherein the plurality of predetermined values correspond to values for the evaluation items associated with a sound quality that is preferred by the group of sound quality evaluators.

37. The apparatus of claim 36, wherein the plurality of predetermined values are organized into a look-up table.

38. The apparatus of claim 28, wherein the processor further adds each of the at least one calculated sound quality factor score to obtain a total sound quality score.

39. The apparatus of claim 38, wherein the selected measuring mode is one of an anechoic mode and a room mode.

40. The apparatus of claim 39, wherein if the selected measuring mode is determined as the anechoic mode, the processor further measures an impulse response of the sound signal, and measures directivity data of the sound signal from the audio system.

41. The apparatus of claim 39, wherein if the selected measuring mode is determined as the room mode, the apparatus further measures an impulse response of the sound signal, and measures data for all channels in the sound signal according to a specification of the audio system.

42. The apparatus of claim 41, wherein if the selected measuring mode is determined to be the room mode, the plurality of evaluation items include one or more of a front channel stereo matching, a rear channel spectral deviation, and a rear channel level matching.

43. The apparatus of claim 28, wherein the processor further obtains subjective sound quality criteria from a group of sound quality evaluators, and creates objective sound quality criteria according to the subjective sound quality criteria of all the sound quality evaluators in the group to obtain the predetermined values.

44. The apparatus of claim 28, further comprising:
one or more speakers to output the audio signal; and
a turntable to rotate the one or more speakers so that directivity data of the audio signal is measured in an anechoic measuring mode.

45. An apparatus to evaluate sound quality of an audio system, comprising:
a signal processor to calculate values of one or more evaluation items of an audio signal, access a score map to map the calculated values of the one or more evaluation items to one or more corresponding scores stored in a memory, and add the one or more corresponding scores of the one or more evaluation items to calculate a total sound quality score.

46. A computer readable medium including executable code to evaluate sound quality of an audio system, the medium comprising:
executable code to evaluate values of one or more evaluation items of an audio signal;
executable code to access a score map to map the calculated values of the one or more evaluation items to one or more corresponding scores stored in the memory; and
executable code to add the one or more corresponding scores of the one or more evaluation items to calculated a total sound quality score.

47. The computer readable medium of claim 46, further comprising:
executable code to process one or more subjective scores for one or more predetermined values for the one or more evaluation items;
executable code to correlate the one or more subjective scores with the one or more predetermined values for the one or more evaluation items; and
executable code to store the correlations in memory as the score map.
